(19) United States
(12) Patent Application Publication
(10) Pub. No.: US 2026/0228280 A1
(43) Pub. Date: Aug. 6, 2026

(54) PALETTIZATION OF KERNEL VECTOR WITH LOOK-UP TABLES IN NEURAL NETWORK PROCESSOR

(71) Applicant: APPLE INC., Cupertino, CA (US)

(72) Inventor: Sung Hee Park, Cupertino, CA (US)

(73) Assignee: APPLE INC., Cupertino, CA (US)

(21) Appl. No.: 19/042,451

(22) Filed: Jan. 31, 2025

(51) Int. Cl. G06F 16/901; G06F 16/25

(52) U.S. Cl. CPC G06F 16/9017; G06N 3/063

(57) ABSTRACT

Embodiments of the present disclosure relate to a neural processor circuit including a kernel access circuit and at least a neural engine circuit including output channels. The kernel access circuit can access kernel data including a first look-up table (LUT) and a second LUT. The neural engine circuit can further include a kernel extract circuit configured to extract the first LUT from the kernel data and assign the first LUT for computing outputs of output channels of a first output channel group (OCG) of the output channels, and extract the second LUT from the kernel data and assign the second LUT for computing outputs of output channels of a second OCG of the output channels.

### BACKGROUND

### Field

The present disclosure relates to palettizing kernel vectors for performing neural network operations, and more specifically to kernel coefficients as palettized vectors stored in look-up tables (LUTs).

### Description

An artificial neural network (ANN) is a computing system or model that uses a collection of connected nodes to process input data. The ANN can be organized into layers, where different layers perform different types of transformation on their input. Extensions or variants of the ANN, such as convolution neural network (CNN), recurrent neural networks (RNN), and deep belief networks (DBN), have received attention. These computing systems or models can involve extensive computing operations, including multiplication and accumulation. For example, CNN is a class of machine learning techniques that uses convolution between input data and kernel data, which can be decomposed into multiplication and accumulation operations.

Depending on the types of input data and operations to be performed, these machine learning systems or models can be configured differently. Such varying configurations can include, for example, pre-processing operations, the number of channels in input data, kernel data to be used, non-linear functions to be applied to convolution results, and applications of various post-processing operations. These operations can consume significant computing system bandwidth, as well as increase the overall power consumption.

### SUMMARY

Embodiments relate to decompressing a kernel for performing neural network operations in a neural processor circuit using a look-up table (LUT), where kernel coefficients are stored in each entry of the LUT. The neural processor circuit includes a kernel access circuit coupled to a neural engine circuit. The kernel access circuit is configured to access kernel data, including index data and a LUT having entries. A first entry is identified by a first index and includes first kernel coefficients and a second entry is identified by a second index and includes second kernel coefficients. The index data includes indices with the first index and the second index. The neural engine circuit is configured to receive the kernel data from the kernel access circuit. The neural engine circuit includes a kernel extract circuit and a multiply-add (MAD) circuit coupled to the kernel extract circuit. The kernel extract circuit is configured to extract the LUT and index data from the kernel data. The kernel access circuit is also configured to assemble an uncompressed kernel data by combining the first kernel coefficients with the second kernel coefficients. The MAD circuit is configured to receive the uncompressed kernel data and perform neural network operations on a portion of input data using the uncompressed kernel data.

In some embodiments, a neural processor circuit can include a kernel access circuit and a neural engine circuit including output channels. The kernel access circuit can access kernel data including a first LUT having first entries, a second LUT having second entries, and index data including indices. The neural engine circuit can receive the kernel data from the kernel access circuit. The neural engine circuit can further include a kernel extract circuit configured to extract the first LUT and the index data from the kernel data and assign the first LUT and the index data for computing outputs of output channels of a first output channel group (OCG) of the output channels. In addition, the kernel extract circuit can extract the second LUT from the kernel data and assign the second LUT and the index data for computing outputs of output channels of a second OCG of the output channels. In some embodiments, the first LUT can be different from the second LUT.

### BRIEF DESCRIPTION OF THE DRAWINGS

FIG. 1 is a high-level diagram of an electronic device, according to some embodiments.

FIG. 2 is a block diagram illustrating components in an electronic device, according to some embodiments.

FIG. 3 is a block diagram illustrating a neural processor circuit, according to some embodiments.

FIG. 4 is a block diagram of a neural engine having multiple output channels in a neural processor circuit, according to some embodiments.

FIGS. 5A and 5B are block diagrams illustrating the flow of compressed kernel data to neural engines, according to some embodiments.

FIGS. 6A and 6B are diagrams illustrating the use of a look-up table (LUT) with or without a block sparse mask to generate decoded kernel coefficients, according to some embodiments.

FIGS. 7A and 7B are block diagrams of a kernel extract circuit, according to some embodiments.

FIGS. 8A and 8B are flow charts illustrating a process of decompressing compressed kernel data, according to some embodiments.

FIG. 9 is a block diagram illustrating multiple LUTs being assigned to output channels of multiple output channel groups (OCG) of neural engine circuits of a neural processor circuit, according to some embodiments.

FIGS. 10A-10C are diagrams illustrating multiple LUTs assigned to output channels of multiple output channel groups (OCG) of neural engine circuits of a neural processor circuit, according to some embodiments.

FIG. 11 is an illustration of an example computer system for implementing some embodiments or portion(s) thereof of the disclosure provided herein, according to some embodiments.

The figures depict and the detail description describes various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to decompressing a kernel for neural network operations in a neural processor circuit, using a look-up table (LUT) with each of its entries associated with kernel coefficients. Index data in compressed kernel data includes indices that indicate entries in the LUT. During decompression, all kernel coefficients in entries as indicated by the indices of the index data are retrieved and assembled into the decompressed kernel, according to some embodiments. A block sparse mask may also be used to indicate a block of locations in the uncompressed kernel to be filled with zero values. In some embodiments, only one or more blocks of locations indicated by the block sparse mask to include at least one none-zero kernel coefficient may be populated with the kernel coefficients from the LUT, while remaining blocks of locations are padded with zero.

In some embodiments, look-up tables (LUTs) can be used for kernel coefficients in a single task computed by a neural processor circuit having one or more neural engine circuits. Each output channel of a neural engine circuit can be assigned to a palette group of output channels having its own LUT for kernel coefficients. Additionally, an output channel group (OCG) of the neural engine circuit can have its own LUT for kernel coefficients. By using different LUTs for each output channel or output channel group, kernel coefficients of finer granularity can be used for processing by the neural processor circuit to improve the speed and efficiency of operations performed by the neural engine circuits and the neural processor circuit.

### Exemplary Electronic Device

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with Figure (FIG.) 1 (e.g., device 100) may include a touch-sensitive surface for receiving user input. The electronic device may also include one or more other physical user-interface devices, such as a physical keyboard, a mouse and/or a joystick.

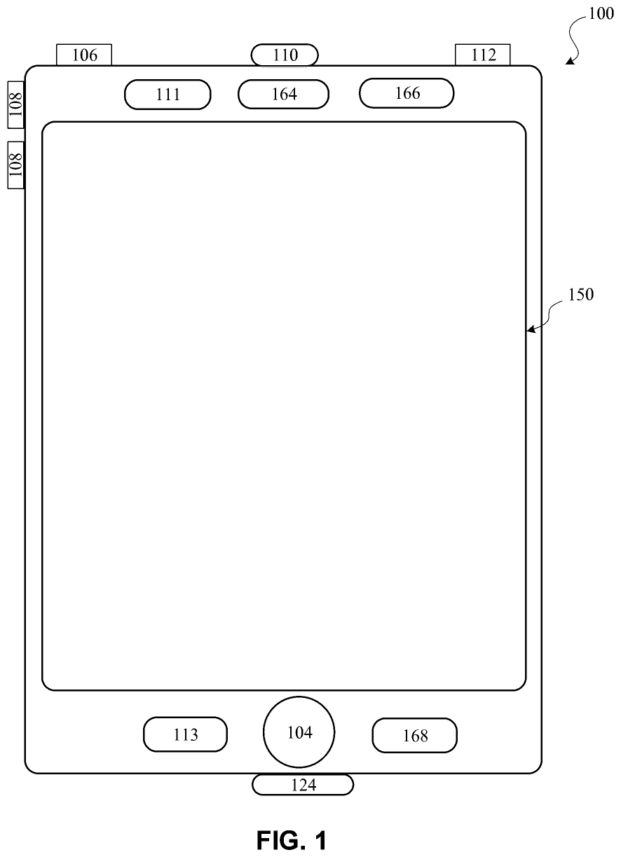

FIG. 1 is a high-level diagram of an electronic device 100, according to some embodiments. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1 such as an ambient light sensor, a dot projector and a flood illuminator that is to support facial recognition.

Device 100 is one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application-specific integrated circuits (ASICs).

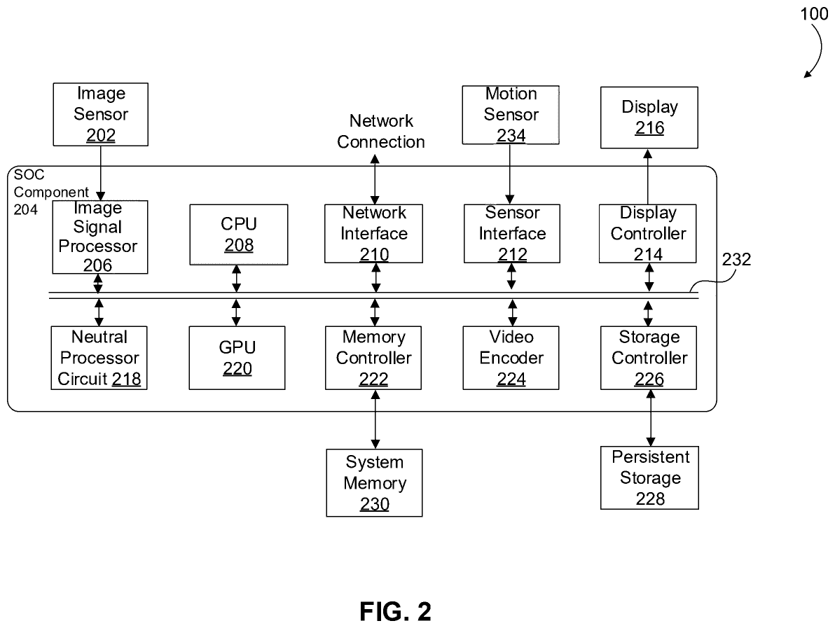

FIG. 2 is a block diagram illustrating components in device 100, according to some embodiments. Device 100 may perform various operations including implementing one or more machine learning models. For this and other purposes, device 100 may include, among other components, image sensors 202, a system-on-a chip (SOC) component 204, a system memory 230, a persistent storage (e.g., flash memory) 228, a motion sensor 234, and a display 216. The components as illustrated in FIG. 2 are merely illustrative. For example, device 100 may include other components (such as speaker or microphone) that are not illustrated in FIG. 2. Further, some components (such as motion sensor 234) may be omitted from device 100.

An image sensor 202 is a component for capturing image data and may be embodied, for example, as a complementary metal-oxide-semiconductor (CMOS) active-pixel sensor) a camera, video camera, or other device. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern.

Motion sensor 234 is a component or a set of components for sensing motion of device 100. Motion sensor 234 may generate sensor signals indicative of orientation and/or acceleration of device 100. The sensor signals are sent to SOC component 204 for various operations, such as turning on device 100 or rotating images displayed on display 216.

Display 216 is a component for displaying images as generated by SOC component 204. Display 216 may include, for example, liquid crystal display (LCD) device or an organic light-emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof.

Persistent storage 228 is a component for storing data in a non-volatile manner. Persistent storage 228 retains data even when power is not available. Persistent storage 228 may be embodied as read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs), such as kernel SVMs, and artificial neural networks (ANNs) such as convolutional network networks (CNNs), recurrent network networks (RNNs), autoencoders, and long short term memory (LSTM). A machine learning model may be an independent model that works with the neural processor circuit 218 and various software applications or sensors of device 100. A machine learning model may also be part of a software application. The machine learning models may perform various tasks, such as facial recognition, image classification, object, concept, and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results in runtime using the models. For example, device 100 captures facial images of the user and uses the images to continue to improve a machine learning model that is used to lock or unlock the device 100.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 is a circuit that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations, such as image translation operations, horizontal and vertical scaling, color space conversion, and/or image stabilization transformations.

CPU 208 may be embodied using any suitable instruction set architecture and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

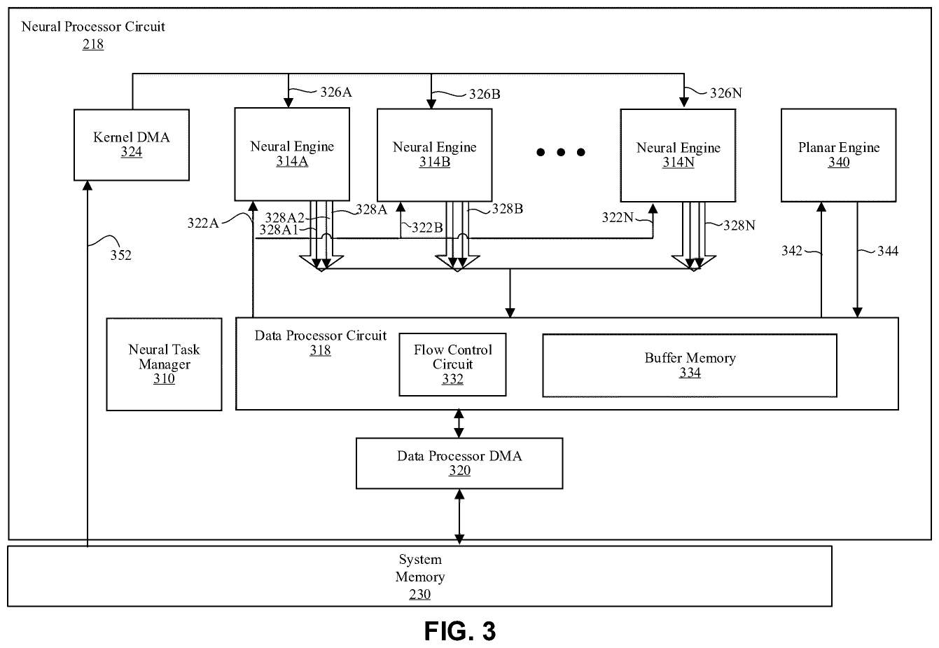

Neural processor circuit 218 is a circuit that performs various machine learning operations based on computation including multiplication, addition, and accumulation. Such computation may be arranged to perform, for example, various types of tensor multiplications such as tensor product and convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, the image signal processor 206, persistent storage 228, system memory 230 or other sources such as network interface 210 or GPU 220. The output of neural processor circuit 218 may be provided to various components of device 100 such as image signal processor 206, system memory 230 or CPU 208 for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to image signal processor 206) and display. The networks may include, but are not limited to, Local Area Networks (LANs) (e.g., an Ethernet or corporate network) and Wide Area Networks (WANs). The image data received via network interface 210 may undergo image signal processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on neural processor circuit 218, ISP 206, CPU 208 or GPU 220. Such software components may be stored in system memory 230, persistent storage 228 or another device communicating with device 100 via network interface 210.

### Example Neural Processor Circuit

Neural processor circuit 218 is a programmable circuit that performs machine learning operations on the input data of neural processor circuit 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as “hidden layers.” Each layer may include one or more nodes, which may be fully or partially connected to other nodes in adjacent layers. In forward propagation, the neural network performs computation in the forward direction based on outputs of a preceding layer. The operation of a node may be defined by one or more functions. The functions that define the operation of a node may include various computation operation such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Example activation functions may include step functions, linear functions, sigmoid functions, hyperbolic tangent functions (tanh), and rectified linear unit functions (ReLU). After a batch of data of training samples passes through a neural network in the forward propagation, the results may be compared to the training labels of the training samples to compute the network's loss function, which represents the performance of the network. In turn, the neural network performs backpropagation by using coordinate descent, such as stochastic coordinate descent (SGD), to adjust the coefficients in various functions to improve the value of the loss function.

In training, device 100 may use neural processor circuit 218 to perform all or some of the operations in the forward propagation and backpropagation. Multiple rounds of forward propagation and backpropagation may be performed by neural processor circuit 218, solely or in coordination with other processors. such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

For prediction or inference, device 100 may receive one or more input samples. Neural processor circuit 218 may take the input samples to perform forward propagation to determine one or more results. The input samples may be images, speeches, text files, sensor data, or other data.

Data and functions (e.g., input data, kernels, functions, layers outputs, gradient data) in machine learning may be saved and represented by one or more tensors. Operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank, and size manipulation, etc.

While the training and runtime of a neural network is discussed as an example, neural processor circuit 218 may also be used for the operations of other types of machine learning models, such as a kernel SVM.

Referring to FIG. 3, an example neural processor circuit 218 may include, among other components, a neural task manager 310, neural engines 314A through 314N (hereinafter collectively referred as “neural engines 314” and individually also referred to as “neural engine 314”), a kernel direct memory access (DMA) 324, a data processor circuit 318, a data processor DMA 320, and a planar engine 340. Neural processor circuit 218 may include fewer or additional components not illustrated in FIG. 3.

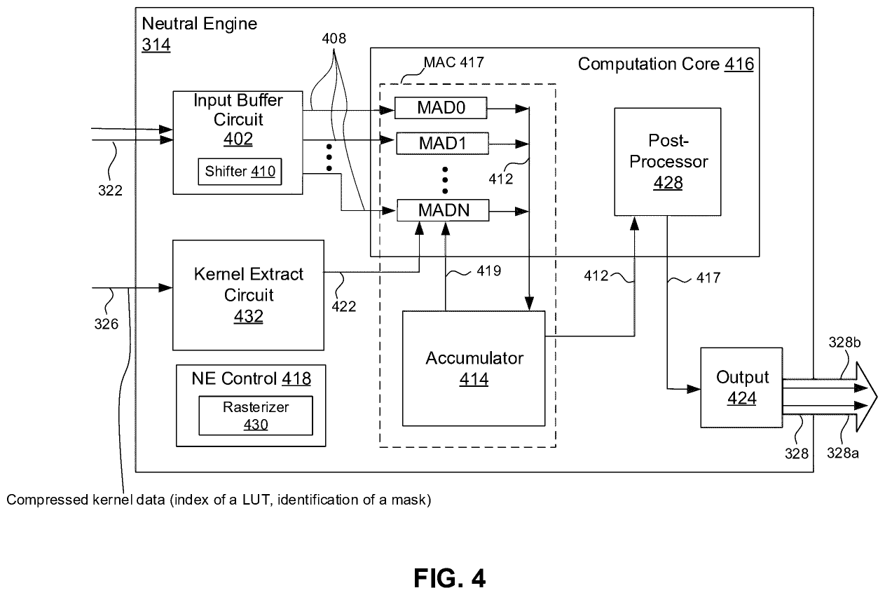

Each of neural engines 314 performs computing operations for machine learning in parallel. Depending on the load of operation, the entire set of neural engines 314 may be operational or a subset of the neural engines 314 may be operational while the remaining neural engines 314 are placed in a power-saving mode to conserve power. Each of neural engines 314 includes components for storing one or more kernels, for performing multiply-accumulate operations, and for post-processing to generate an output data 328, as described below in detail with reference to FIG. 4. Neural engines 314 may specialize in performing computation heavy operations such as convolution operations and tensor product operations. Convolution operations may include different kinds of convolutions, such as cross-channel convolutions (a convolution that accumulates values from different channels), channel-wise convolutions, and transposed convolutions.

Planar engine 340 may specialize in performing simpler computing operations whose speed may depend on the input and output (I/O) speed of the data transmission instead of the computation speed within planar engine 340. Those computing operations may be referred to as “I/O bound computations.” In contrast, neural engines 314 may focus on complex computation whose speed may depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In some embodiments, input data may be a tensor whose rank is larger than three (e.g., having three or more dimensions). A set of dimensions (two or more) in the tensor may be referred to as a “plane” while another dimension may be referred to as a “channel.” Neural engines 314 may convolve data of a plane in the tensor with a kernel and accumulate results of the convolution of different planes across different channels. On the other hand, planar engine 340 may specialize in operations within the plane.

The circuitry of planar engine 340 may be programmed for operation in one of multiple modes, including a pooling mode, an elementwise mode, and a reduction mode. In the pooling mode, planar engine 340 reduces a spatial size of input data. In the elementwise mode, planar engine 340 generates an output that is derived from elementwise operations of one or more inputs. In the reduction mode, planar engine 340 reduces the rank of a tensor.

Neural task manager 310 manages the overall operation of neural processor circuit 218. Neural task manager 310 may receive a task list from a compiler executed by CPU 208, store tasks in its task queues, choose a task to perform, and send task commands to other components of neural processor circuit 218 for performing the chosen task. Data may be associated with a task command that indicates the types of operations to be performed on the data. Data of neural processor circuit 218 includes input data that is transmitted from another source, such as system memory 230, and data generated by neural processor circuit 218 in a previous operating cycle. Each dataset may be associated with a task command that specifies the type of operations to be performed on the data. Neural task manager 310 may also perform switching of tasks on detection of events such as receiving instructions from CPU 208. In some embodiments, neural task manager 310 sends rasterizer information to the components of neural processor circuit 218 to enable each of the components to track, retrieve or process appropriate segments of the input data and kernel data. For example, neural task manager 310 may include registers that store the information regarding the size and rank of a dataset for processing by neural processor circuit 218. Although neural task manager 310 is illustrated in FIG. 3 as part of neural processor circuit 218, neural task manager 310 may be a component outside neural processor circuit 218.

Kernel DMA 324 is a read circuit that fetches kernel data 352 from a source (e.g., system memory 230), processes (e.g., replicates or devices) kernel data 352 into neural engine (NE) kernel data 326A through 326N appropriate for each neural engines, and sends NE kernel data 326A through 326N to each of neural engines 314. NE kernel data 326A through 326N represents information from which kernel coefficients can be extracted, and kernel data 352 represents information from which NE kernel data 326 through 326N can be derived. In some embodiments, the kernel data 352 or NE kernel data 326 may be in a compressed format which is decompressed at each of neural engines 314. Although NE kernel data provided to each of neural engines 314 may be the same in some instances, the NE kernel data provided to each of neural engines 314 is different in most instances. In some embodiments, the direct memory access nature of kernel DMA 324 may allow kernel DMA 324 to fetch and write data directly from the source without the involvement of CPU 208.

Data processor circuit 318 manages data traffic and task performance of neural processor circuit 218. Data processor circuit 318 may include a flow control circuit 332 and a buffer memory 334. Buffer memory 334 is temporary storage for storing data associated with operations of neural processor circuit 218 and planar engine 340, such as input data that is transmitted from system memory 230 (e.g., data from a machine learning model) and other data that is generated within neural processor circuit 218 or planar engine 340. The data stored in data processor circuit 318 may include different subsets that are sent to various downstream components, such as neural engines 314 and planar engine 340.

In some embodiments, buffer memory 334 is embodied as a non-transitory memory that can be accessed by neural engines 314 and planar engine 340. Buffer memory 334 may store input data 322A through 322N for feeding to corresponding neural engines 314A through 314N or planar engine 340, as well as output data 328A through 328N from each of neural engines 314A through 314N or planar engine 340 for feeding back into one or more neural engines 314 or planar engine 340, or sending to a target circuit (e.g., system memory 230). In some embodiments, output data 328A through 328N from each of neural engines 314A through 314N can include multiple output channels. In some embodiments, output data 328A can include data for an output channel 328a and data for an output channel 328b. There can be other number of channels for output data 328A. In some embodiments, output data for neural engines 314A through 314N can include data for various number of output channels. Buffer memory 334 may also store input data 342 and output data 344 of planar engine 340 and allow the exchange of data between neural engine 314 and planar engine 340. For example, one or more output data 328A through 328N of neural engines 314 are used as input data 342 to planar engine 340. Likewise, output data 344 of planar engine 340 may be used as the input data 322A through 322N of neural engines 314. The inputs of neural engines 314 or planar engine 340 may be any data stored in buffer memory 334. For example, in various operating cycles, the source datasets from which one of the engines fetches as inputs may be different. The input of an engine may be an output of the same engine in previous operating cycles, outputs of different engines, or any other suitable source datasets stored in buffer memory 334. Also, a dataset in buffer memory 334 may be divided and sent to different engines for different operations in the next operating cycle. Two datasets in buffer memory 334 may also be joined for the next operation.

Flow control circuit 332 of data processor circuit 318 may control the exchange of data between neural engines 314 and planar engine 340. The operations of data processor circuit 318 and other components of neural processor circuit 218 are coordinated so that the input data and intermediate data stored in data processor circuit 318 may be reused across multiple operations at neural engines 314 and planar engine 340, thereby reducing data transfer to and from system memory 230. Flow control circuit 332 may perform one or more of the following operations: (i) monitor the size and rank of data (e.g. data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., the data processor circuit 318 may operate in a broadcast mode where the same data is fed to multiple input channels of neural engines 314 so that multiple or all neural engines 314 receive the same data or in a unicast mode where different neural engines 314 receives different data), and (iv) transmit a configuration command to the planar engine 340 to direct planar engine 340 to program itself for operating in one of multiple operation modes.

The data of neural processor circuit 218 stored in buffer memory 334 may be part of, among others, image data, histogram of oriented gradients (HOG) data, audio data, metadata, output data 328 of a previous operating cycle of neural engine 314, and other processed data received from other components of SOC component 204.

Data processor DMA 320 includes a read circuit that receives a segment of the input data from a source (e.g., system memory 230) for storing in buffer memory 334, and a write circuit that forwards data from buffer memory 334 to a target component (e.g., system memory 230). In some embodiments, the direct memory access nature of data processor DMA 320 may allow data processor DMA 320 to fetch and write data directly from a source (e.g., system memory 230) without the involvement of CPU 208. Buffer memory 334 may be a direct memory access buffer that stores data of a machine learning model of device 100 without involvement of CPU 208.

### Example Neural Engine Architecture

FIG. 4 is a block diagram of neural engine 314, according to some embodiments. Neural engine 314 performs various operations to facilitate machine learning, such as convolution, tensor product, and other operations that may involve heavy computation. For this purpose, neural engine 314 receives input data 322, performs multiply-accumulate operations (e.g., convolution operations) on input data 322 based on an uncompressed kernel, performs further post-processing operations on the result of the multiply-accumulate operations, and generates output data 328. Input data 322 and/or output data 328 of neural engine 314 may be of a single channel or span across multiple channels. In some embodiments, output data 328 can include data for an output channel 328a and data for an output channel 328b.

Neural engine 314 may include, among other components, input buffer circuit 402, computation core 416, neural engine (NE) control 418, kernel extract circuit 432, accumulator circuit 414 and output circuit 424. Neural engine 314 may include fewer components than what is illustrated in FIG. 4 or include further components not illustrated in FIG. 4.

Input buffer circuit 402 is a circuit that stores a subset of the data of neural processor circuit 218 as the subset of data is received from a source. The source may be data processor circuit 318, planar engine 340, or another suitable component. Input buffer circuit 402 sends an appropriate segment 408 of data for a current task or process loop to computation core 416 for processing. Input buffer circuit 402 may include a shifter 410 that shifts read locations of input buffer circuit 402 to change segment 408 of data sent to computation core 416. By changing segments of input data provided to computation core 416 via shifting, neural engine 314 can perform multiply-accumulate for different segments of input data based on a fewer number of read operations. In some embodiments, the data of neural processor circuit 218 includes data associated with convolution groups and/or input channels.

Kernel extract circuit 432 is a circuit that receives NE kernel data 326 from kernel DMA 324 and extracts kernel coefficients 422. In some embodiments, kernel extract circuit 432 references a lookup table (LUT) and uses a block sparse mask to reconstruct a kernel from compressed NE kernel data 326 based on the LUT. The block sparse mask indicates blocks of locations in the reconstructed kernel to be padded with zero and remaining locations to be filled with numbers. Kernel coefficients 422 of the reconstructed kernel are sent to computation core 416 to populate register in multiply-add (MAD) circuits of computation core 416.

Computation core 416 is a programmable circuit that performs computation operations. For this purpose, computation core 416 may include MAD circuits MAD0 through MADN and a post-processor 428. Each of MAD circuits MAD0 through MADN may store an input value in segment 408 of the input data and a corresponding kernel coefficient in kernel coefficients 422. The input value and the corresponding kernel coefficient are multiplied in each of MAD circuits to generate a processed value 412.

Accumulator circuit 414 is a memory circuit that receives and stores processed values 412 from MAD circuits. The processed values stored in accumulator circuit 414 may be sent back as feedback information 419 for further multiply and add operations at MAD circuits or sent to post-processor 428 for post-processing. Accumulator circuit 414 in combination with MAD circuits form a multiply-accumulator (MAC) 404. In some embodiments, accumulator circuit 414 may have subunits (or batches) where each subunit sends data to different components of neural engine 314. For example, during an operating cycle, data stored in a first subunit of accumulator circuit 414 is sent to MAC 404 while data stored in a second subunit of accumulator circuit 414 is sent to post-processor 428.

Post-processor 428 is a circuit that performs further processing of values 412 received from accumulator circuit 414. Post-processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN)). The result of such operations is output from post-processor 428 as processed values 417 to output circuit 424. In some embodiments, the processing at post-processor 428 is bypassed. For example, the data in accumulator circuit 414 may be sent directly to output circuit 424 for access by other components of neural processor circuit 218.

NE control 418 controls operations of other components of neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator circuit 414 to MAD circuits, and perform different types of post-processing operations at post-processor 428. To configure components of neural engine 314 to operate in a desired manner, NE control 418 sends task commands that may be included in information 419 to components of neural engine 314. NE control 418 may include a rasterizer 430 that tracks the current task or process loop being processed at neural engine 314.

Input data can be split into smaller pieces of data for parallel processing at multiple neural engines 314 or neural engines 314 and planar engine 340. A set of data used for a convolution operation may be referred to as a “convolution group,” which can be split into multiple smaller units. The hierarchy of smaller units (segments) may be convolution groups, slices, tiles, work units, output channel groups, input channels (Cin), sub-Cins for input stride, etc. For example, a convolution group may be split into several slices; a slice may be split into several tiles; a tile may be split into several work units; and so forth. In the context of neural engine 314, a work unit may be a segment of the input data, such as data processed by planar engine 340 or data processed during a prior operating cycle of neural engines 314 having a size that produces output values that fit into accumulator circuit 414 of neural engine 314 during a single operating cycle of computation core 416. In one case, the size of each work unit is 256 bytes. In some embodiments, work units can be shaped to one of 16×16, 32×8, 64×4, 128×2 or 256×1 datasets. In the context of planar engine 340, a work unit may be (i) a segment of input data, (ii) data from neural engine 314 or (iii) data from a prior operating cycle of planar engine 340 that can be processed simultaneously at planar engine 340.

Rasterizer 430 may perform the operations associated with dividing the input data into smaller units (segments) and regulate the processing of the smaller units through MACs 404 and accumulator circuit 414. Rasterizer 430 keeps track of sizes and ranks of segments of the input/output data (e.g., groups, work units, input channels, output channels) and instructs the components of neural processor circuit 218 for proper handling of the segments of the input data. For example, rasterizer 430 operates shifters 410 in input buffer circuits 402 to forward correct segments 408 of input data to MAC 404 and send the finished output data 328 to data buffer memory 334. Other components of neural processor circuit 218 (e.g., kernel DMA 324, buffer DMA 320, buffer memory 334, planar engine 340) may also have their corresponding rasterizers to monitor the division of input data and the parallel computation of various segments of input data in different components.

Output circuit 424 receives processed values 417 from post-processor 428 and interfaces with data processor circuit 318 to store processed values 417 in data processor circuit 318. For this purpose, output circuit 424 may send out output data 328 in a sequence or a format that is different from the sequence or format in which the processed values 417 are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include, but are not limited to, mapping between input data elements and kernel elements, the number of input channels, the number of output channels, performing of output strides, and enabling/selection of post-processing operations at post-processor 428.

### Example Distribution and Decompression of Kernel Data

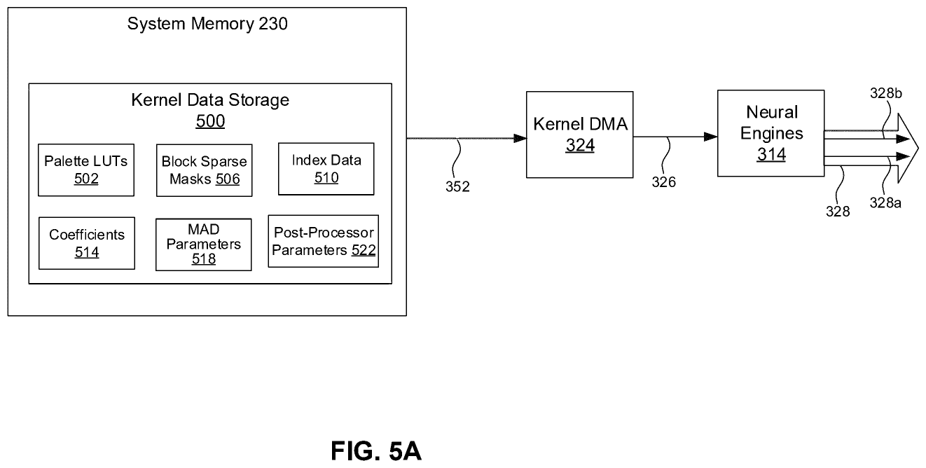

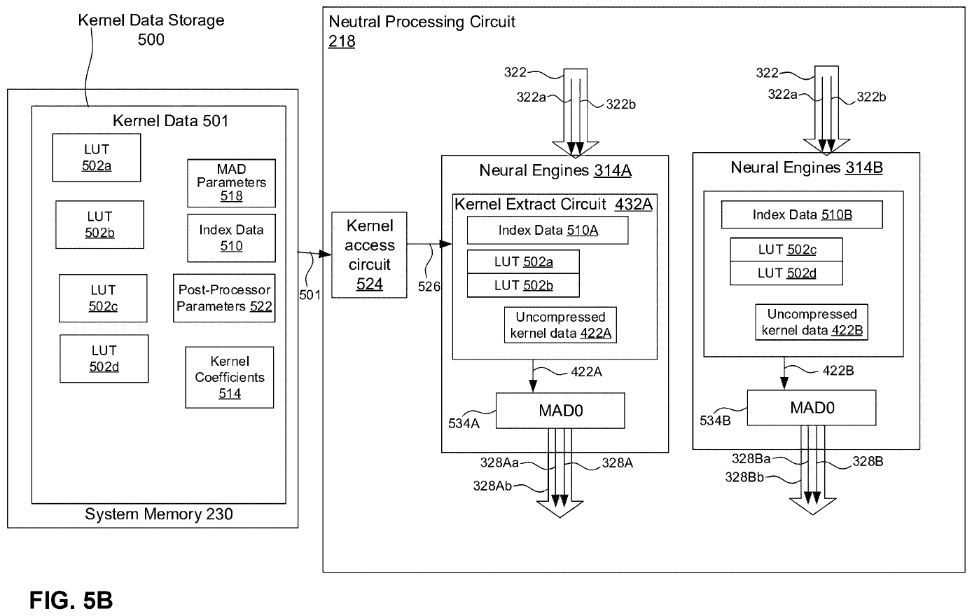

FIG. 5A is a block diagram illustrating flow of compressed kernel data to neural engine 314, according to some embodiments. System memory 230 includes kernel data storage 500 that stores kernel data associated with performing neural operations on neural engines 314. The kernel data in kernel data storage 500 may be generated during a compilation process and may include data for multiple levels of ANN and/or multiple ANNs.

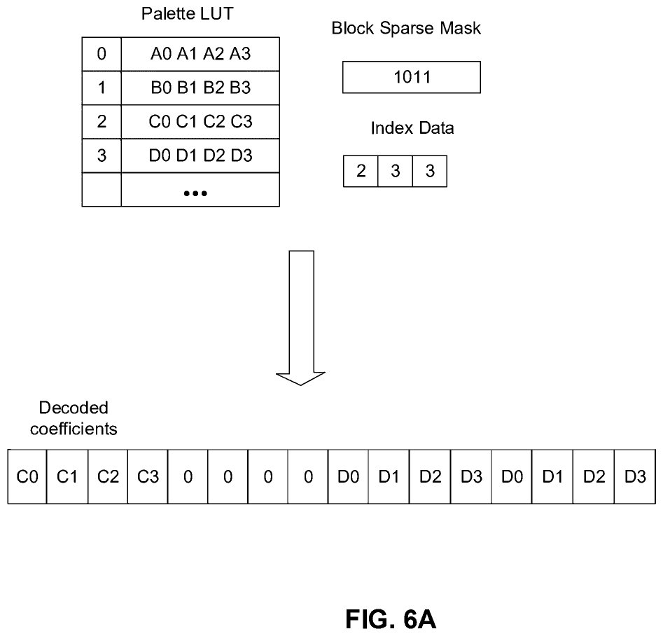

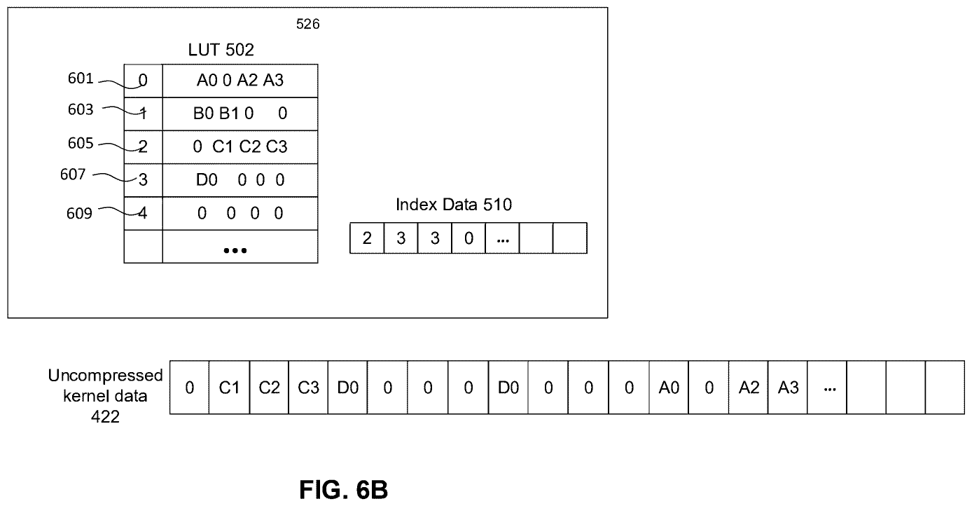

Kernel data stored in kernel data storage 500 may include information for assembling kernels at neural engines 314, as well as other information for performing neural processing operation at neural engines 314. Information for assembling kernels may include, among other data, look-up tables (LUTs) 502, block sparse masks 506, index data 510, and kernel coefficients 514, as described below in detail with reference to FIG. 6A. The other information for neural engines 314 may include MAD parameters 518 and post-processor parameters 522. MAD parameters 518 indicate configurations or processes of MAD in neural engines 314 and may include a channel bias or a shift to be used with an operation. Post-processor parameters 522 indicate configurations or processes at post-processor 428 and may include a function to be used for processing values 412 generated by MAC 404. Kernel data storage 500 stores information for multiple layers and/or different ANNs.

Kernel DMA 324 fetches kernel data 352 relevant to current or subsequent neural operations and assembles kernel data 352 into NE kernel data 326 to be sent to each of neural engines 314 for producing output data 328. In some embodiments, output data 328 can include data for an output channel 328a and data for an output channel 328b. Kernel data storage 500 may include data for different layers of ANN or multiple ANNs, and hence, kernel DMA 324 collects, from kernel data storage 500, index data 510, parts of kernel data 352 that is applicable to current or subsequent operation of neural engines 314, packs the collected data into a predetermined format, and sends the collected data as NE kernel data 326 to neural engines 314. In some embodiments, NE kernel data 326 may be in the form of a data block that includes a LUT with entries of coefficient identifiers and a block sparse mask followed by coefficient values mapped to the coefficient identifiers. Each entry in the LUT includes identifiers for multiple coefficients, as described below in detail with reference to FIG. 6A.

FIG. 5B is a block diagram illustrating flow of providing kernel data to neural processor circuit 218 including neural engine 314A and neural engine 314B, according to some embodiments. In some embodiments, neural engine 314A or 314B may be referred to as a “neural engine circuit” and can be collectively referred to as “neural engines 314.” System memory 230 includes kernel data storage 500 that stores kernel data 501 associated with performing neural operations on neural engines 314. Kernel data 501 in kernel data storage 500 may be generated during a compilation process and may include data for multiple levels of ANN or multiple ANNs.

In some embodiments, kernel data 501 stored in kernel data storage 500 may include information for assembling kernels at neural engines 314, as well as other information for performing neural processing operation at neural engines 314. Accordingly, kernel data 501 can include information for assembling kernels, such as LUTs 502 (including a LUT 502a, LUT 502b, LUT 502c, LUT 502d), index data 510, and kernel coefficients 514, as described below in detail with reference to FIGS. 6A and 6B. In some embodiments, kernel data 501 can include block sparse masks, such as block sparse masks 506 shown in FIG. 5A. In some embodiments, kernel data 501 does not include block sparse masks to reduce the storage used in storing kernel data 501. In addition, kernel data 501 can include other information for neural engines 314, such as MAD parameters 518 and post-processor parameters 522. MAD parameters 518 indicate configurations or processes of MAD in neural engines 314 and can include a channel bias or a shift to be used with an operation. Post-processor parameters 522 indicate configurations or processes at post-processor 428 and may include a function to be used for processing values 412 generated by MAC 404. Kernel data storage 500 stores information for multiple layers and/or different ANNs.

In some embodiments, kernel access circuit 524 can fetch some or all of kernel data 501 relevant to current or subsequent neural operations and assemble kernel data 501 into NE kernel data 526 to be sent to each of neural engines 314. In some embodiments, kernel access circuit 524 can be coupled to system memory 230 external to neural processor circuit 218. Kernel access circuit 524 can be configured to access kernel data 501 stored in system memory 230, where kernel data 501 can include one or more LUTs 502 and index data 510 including indices. In some embodiments, kernel access circuit 524 can be implemented as kernel DMA 324 as shown in FIG. 5A. Kernel data 501 may include data for different layers of ANN or multiple ANNs. In some embodiments, kernel access circuit 524 can collect or retrieve parts of kernel data 501 stored in kernel data storage 500, such as a part of index data 510, which is applicable to current or subsequent operation of neural engines 314. In addition, kernel access circuit 524 can transform the collected kernel data 501 into a predetermined format and send the collected data as NE kernel data 526 to neural engines 314. In some embodiments, kernel data 501 or NE kernel data 526 may be in a compressed format that is decompressed at each of neural engines 314. In some embodiments, NE kernel data 526 may be in the form of a data block that includes a LUT with entries of coefficient identifiers followed by coefficient values mapped to the coefficient identifiers. Each entry in the LUT includes identifiers for multiple coefficients, as described below in detail with reference to FIGS. 6A and 6B.

In some embodiments, neural processor circuit 218 can include one or more neural engines, e.g., neural engine 314A and neural engine 314B. In some embodiments, neural engine 314A can include kernel extract circuit 432A and one or more MAD circuit 534A. Kernel extract circuit 432A can be configured to extract one or more LUTs (such as LUT 502a and LUT 502b of kernel data 501) and extract index data 510A of kernel data 501. LUT 502a or LUT 502b can include entries, in which an entry is identified by an index and includes kernel coefficients. In addition, an index of index data 510A corresponds to the kernel coefficients of the entry in LUT 502a or LUT 502b identified by the index. In some embodiments, kernel extract circuit 432A can assemble uncompressed kernel data 422A by combining a first set of kernel coefficients of the LUTs corresponding to a first index of the index data with a second set of kernel coefficients of the LUTs corresponding to a second index of the index data. In some embodiments, MAD circuit 534A coupled to kernel extract circuit 432A can receive uncompressed kernel data 422A, MAD circuit 534A further can be configured to perform neural network operations on a portion of input data using uncompressed kernel data 422A. In some embodiments, MAD circuit 534A can generate output data 328A, which can include data for an output channel 328Aa and data for an output channel 328Ab. In some embodiments, neural engine 314A can receive input data 322A include input data for multiple input channels (e.g., input data for input channel 322Aa) and input data for input channel 322Ab.

In some embodiments, neural engine 314B can include kernel extract circuit 432B and one or more MAD circuit 534B. Kernel extract circuit 432B can be configured to extract one or more LUTs (such as LUT 502c and LUT 502d of kernel data 501) and extract index data 510B of kernel data 501. LUT 502c or LUT 502d can include entries, in which an entry is identified by an index and includes kernel coefficients. In addition, an index of index data 510B corresponds to the kernel coefficients of the entry in LUT 502c or LUT 502d identified by the index. In some embodiments, kernel extract circuit 432B can assemble uncompressed kernel data 422B by combining a first set of kernel coefficients of the LUTs corresponding to a first index of the index data with a second set of kernel coefficients of the LUTs corresponding to a second index of the index data. In some embodiments, MAD circuit 534B coupled to kernel extract circuit 432B can receive uncompressed kernel data 422B, MAD circuit 534B further can be configured to perform neural network operations on a portion of input data using uncompressed kernel data 422B. In some embodiments, MAD circuit 534B can generate output data 328B, which can include data for an output channel 328Ba and data for an output channel 328Bb. In some embodiments, neural engine 314B can receive input data 322B include input data for multiple input channels (e.g., input data for input channel 322Ba) and input data for input channel 322Bb.

FIG. 6A is a diagram illustrating the use of a LUT and a block sparse mask to generate decoded kernel coefficients or uncompressed kernel data, according to some embodiments. After kernel extract circuit 432 of neural engines 314 receives NE kernel data 326, kernel extract circuit 432 decodes NE kernel data 326 into an uncompressed kernel. Specifically, kernel extract circuit 432 reads the block sparse mask that indicates where one or more blocks of zero kernel coefficients are located and where blocks include at least one non-zero kernel coefficients are located. Then, kernel extract circuit 432 refers to index data that indicates entries in the LUT to identify kernel coefficients to populate blocks with non-zero kernel coefficients. Each entry in the LUT includes coefficient identifiers, where each coefficient identifier corresponds to a kernel coefficient value.

In the embodiment of FIG. 6A, an entry in the LUT includes 4 elements, and the block sparse mask includes 4 digits. The block sparse mask includes 3 non-zero bits and 1 zero bit, and the index data has 3 numbers corresponding to each non-zero bit of the block sparse mask. In the LUT, the first entry (index 0) has four identifiers of A0, A1, A2, A3, the second entry (index 1) has four identifiers of B0, B1, B2, B3, the third entry (index 2) has four identifiers of C0, C1, C2, C3, and the fourth entry (index 3) has four identifiers of D0, D1, D2, D3. The block sparse mask is four bits long, with the second bit being zero and the remaining bits being 1. The bit sequence in the block sparse mask means that the second block of coefficients is all zero, while the remaining blocks include at least one coefficient that is non-zero. Index data indicates that kernel coefficients corresponding to the first block of index data are to be populated using 4 coefficients (C0, C1, C2, C3) in index 2 (third index), while the kernel coefficients corresponding to third and fourth blocks of index data are to be populated using 4 coefficients (D0, D1, D2, D3) in index 3.

The resulting uncompressed kernel includes the first block of four coefficients (C0 through C3), followed by four zero-value coefficients, and then two repeating blocks (D0 through D3) of coefficients. Although FIG. 6A illustrates a series of indices A0 through D3 in decoded coefficients, indices A0 through D3 can be replaced with actual values of coefficients in NE kernel data 326. The series of decoded coefficients 422 is sent to MAD of computation core 416 for performing multiplication operations.

By using the LUT, block sparse mask, and index data, the amount of data stored in kernel data storage 500 may be reduced relative to storing entire kernel coefficients of kernels in kernel data storage 500, while preserving flexibility of using various arrangements of kernel coefficients. That is, a set of coefficients in the LUT that are reused across different blocks may not be stored in duplicate in kernel data storage 500. Further, blocks of zero coefficients are represented by a single bit in block sparse mask, which also reduces the amount of data used for storing sparse kernels.

FIG. 6B is a diagram illustrating the use of a LUT without a block sparse mask to generate decoded kernel coefficients, according to some embodiments. After kernel extract circuit 432 of neural engines 314 receives NE kernel data 526 as shown in FIG. 5B, kernel extract circuit 432 decodes NE kernel data 526 into uncompressed kernel data 422.

In the embodiment of FIG. 6B, LUT 502 can include multiple entries, where an entry of LUT 502 can be identified by an index and includes kernel coefficients. For example, LUT 502 can include an entry 601 with index 0, an entry 603 with index 1, an entry 605 with index 2, an entry 607 with index 3, an entry 609 with index 4, and more. In some embodiments, each of the entries in LUT 502 can include the same number of kernel coefficients. For example, each of entry 601, entry 603, entry 605, entry 607, and entry 609 can include 4 kernel coefficients. Some entries, e.g., entry 601 and entry 602, can include a zero as a kernel coefficient. For example, entry 601 includes kernel coefficients as a list of A0, 0, A2, and A3. In some embodiments, each kernel coefficient of the kernel coefficients in the entry identified by the index can be zero. For example, entry 609 identified by index 4 has each kernel coefficient as 0. Accordingly, a block sparse mask can be avoided to save storage space since an entry with all 0 kernel coefficients can be saved directly into LUT 502. A benefit of on-the-fly sparse encoding can include reducing the footprint for adding sparse masks in low sparsity weights, skipping random zeros in the LUT from vector palettization, and further reducing zeros in dynamic weights. Furthermore, power overhead of on-the-fly sparse encoding can be lower than the encoding with a sparse mask. In some embodiments, there can be two types of memory formats, one memory format with sparse mask and another memory format without sparse mask. Embodiments herein can allow zero skipping for both memory formats. Embodiments herein can mark any zero entries on-the-fly after taking entries from the LUT, so that the info can be used to skip computation in subsequent multiply-add units.

In some embodiments, entry 601 is identified by index 0 and has four kernel coefficients A0, 0, A2, A3. Entry 603 is identified by index 1 and has four kernel coefficients B0, B1, 0, 0. Entry 605 is identified by index 2 and has four kernel coefficients 0, C1, C2, C3. Entry 607 is identified by index 3 and has four kernel coefficients D0, 0, 0, 0.

Index data 510 can include 4 indices: 2, 3, 3, 0. An index of index data 510, such as index 2, corresponds to the kernel coefficients in the entry identified by index 2, which can include 0, C1, C2, C3. Similarly, index 3 of index data 510 can correspond to the kernel coefficients in the entry identified by index 3, which can include D0, 0, 0, 0.

In some embodiments, kernel extract circuit 432 of neural engines 314 can receive NE kernel data 526 as shown in FIG. 6B and can also assemble uncompressed kernel data 422. In some embodiments, kernel extract circuit 432 can extract LUT 502 and index data 510 from kernel data 526. In addition, kernel extract circuit 432 can assemble uncompressed kernel data 422 by combining a first set of kernel coefficients corresponding to a first index of the index data with a second set of kernel coefficients corresponding to a second index of the index data. For example, kernel extract circuit 432 can combine a first set of kernel coefficients (0, C1, C2, C3) corresponding to index 2 of index data 510, with a second set of kernel coefficients (D0, 0, 0, 0) corresponding to index 3 of index data 510. The assembled uncompressed kernel data 422 can be (0, C1, C2, C3, D0, 0, 0, 0). In addition, kernel extract circuit 432 can continue to assemble the set of kernel coefficients corresponding to an index of index data 510, e.g., 2, 3, 3, 0, into uncompressed kernel data 422 including (0, C1, C2, C3, D0, 0, 0, 0, D0, 0, 0, 0, A0, 0, A2, A3). In some embodiments, uncompressed kernel data 422 can be sent to MAD circuit 534 of computation core 416 for performing multiplication operations.

In some embodiments, without using the block sparse mask, blocks of zero coefficients, such as the block of zeros identified by index 4 can be stored directly into LUT 502.

### Example Structure of Kernel Extract Circuit

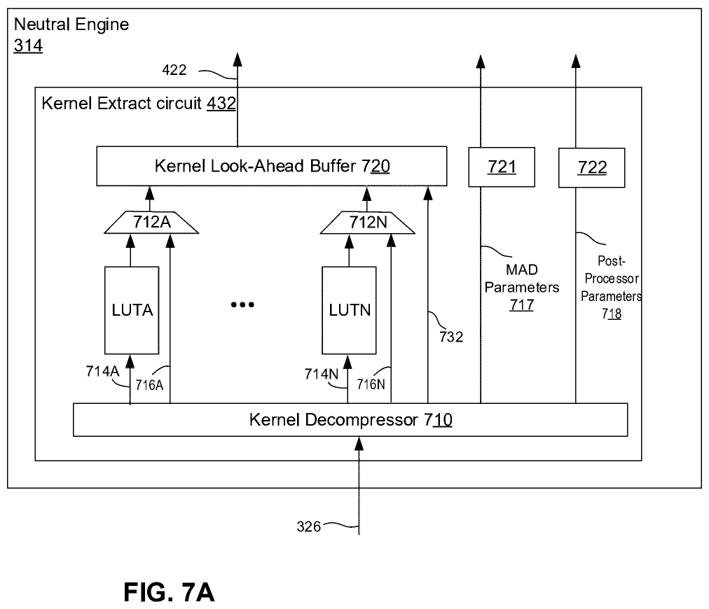

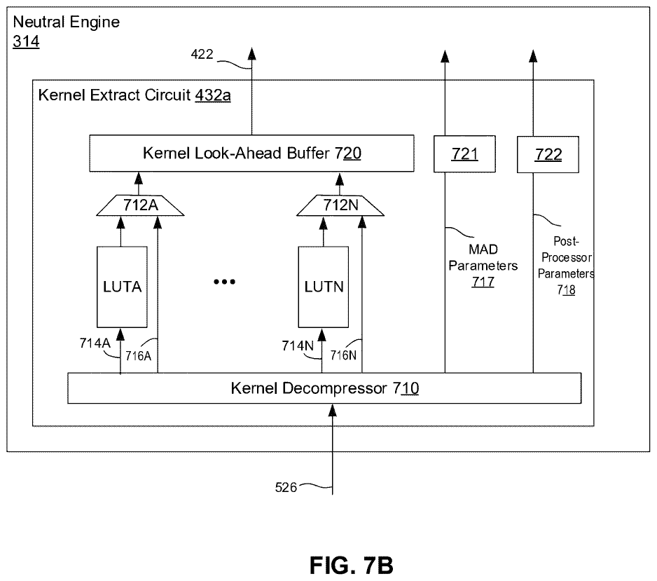

FIG. 7A is a block diagram of kernel extract circuit 432 of neural engines 314, according to some embodiments. Kernel extract circuit 432 receives NE kernel data 326 from kernel DMA 324 circuit and extracts uncompressed kernel coefficients 422.

In some embodiments, kernel extract circuit 432 extracts the uncompressed kernel data by using LUTs, block sparse masks and index data, as described above with reference to FIG. 6A.

Kernel extract circuit 432 may include, among other components, a kernel decompressor 710, palettized look-up table storage LUTA through LUTN, reconstruction circuits 712A through 712N, a kernel look-ahead buffer 720, MAD parameter buffer 721, and post-processor parameter buffer 722. Kernel extract circuit 432 may include fewer or additional components than the components illustrated in FIG. 7A.

Kernel decompressor 710 is a circuit that separates the compressed kernel data 326 and sends it to other components of the kernel extract circuit 432. Kernel decompressor 710 may extract LUT information 714A through 714N, LUT identification 716A through 716N, block sparse mask 732, MAC parameters 717, and post-processor parameters 718 from compressed kernel data 326. To prepare LUT information 714A through 714N, kernel decompressor 710 reads kernel coefficient identifiers for each entry in the LUTs and populates the entries in the LUTs with kernel coefficient values identified by the kernel coefficients identifiers.

Kernel decompressor 710 sends LUT identification 716A through 716N to a corresponding look-up table storage LUTA through LUTN. Each LUT information 714A through 714N may include entries with identifications and corresponding blocks of multiple kernel coefficients. Each LUT identification 716A through 716N may indicate the identification of a LUT (of multiple LUTs) to be used and indices from index data, as described above with reference to FIG. 6A. Kernel decompressor 710 also extracts and sends block sparse mask 732 to kernel decompressor 710 for placing one or more blocks of zero coefficients in a kernel. Although multiple LUTs are illustrated in FIG. 7A as being included in kernel extract circuit 432, only a single LUT may be included in kernel extract circuit 432, according to some embodiments.

Kernel decompressor 710 sends MAD parameters 717 to MAD parameter buffer 721. MAD parameters 717 are sent to the MAD circuit of each of the neural engine circuits to configure operations of the MAD circuit. For example, a MAD parameter 717 includes a channel bias or a shift to be used with an operation.

Kernel decompressor 710 sends post-processor parameters 718 to post-processor parameter buffer 722. Post-processing parameters 718 are sent to a post-processer (e.g., post-processor 428) of each of the neural engine circuits to configure operations of the post-processor. For example, post-processing parameters 718 are values that collectively represent a function used for processing values 412 generated by MAC 404.

LUT storage LUTA through LUTN stores look-up tables storing entries, where each entry is associated with kernel coefficients. Each of the entries is identified by index values in index data. The LUT storage LUTA through LUTN receives LUT information 714A through 714N from kernel decompressor 710. One or more LUTs may be configurable to support various numbers and patterns of kernel coefficients in each of their entries. For example, one or more kernel coefficients in an entry of a LUT may have a zero value. Depending on the number of entries or patterns of kernel coefficients, a single large LUT or more than one smaller LUT may be used.

Reconstruction circuits 712A through 712N reconstruct blocks of kernel coefficients by referencing a LUT identified by a corresponding LUT identification 716A through 716N in the look-up table storage LUTA through LUTN to determine coefficient values to be filled in blocks of kernel where at least one kernel coefficient is non-zero, as indicated by block sparse mask 732. Reconstruction circuit 712A through 712N sends a block of the uncompressed kernel data to a kernel look-ahead buffer 720 for storage.

Kernel look-ahead buffer 720 stores uncompressed kernel data. Kernel look-ahead buffer 720 receives uncompressed blocks of kernel coefficients from reconstruction circuits 712A through 712N. Kernel look-ahead buffer 720 then fills locations of a kernel, where sparse block mask 732 indicates non-zero values with the uncompressed kernel coefficients while filling the remaining locations with zeros. Kernel look-ahead buffer 720 sends information on locations of kernel coefficients that are zero in the uncompressed kernel data to a MAD circuit (e.g., MAD0 through MADN) before sending remaining kernel coefficients that are non-zero to the MAD circuit so that the MAD circuit can skip multiply-add operations associated with the kernel coefficient that are zero.

In some embodiments, kernel look-ahead buffer 720 can be used to generate relevant control signals (e.g., control signals 452) for a computation core 416 in a neural engine 314. Control signals 452 may then instruct neural engine 314 to skip operations for kernel coefficients that have zero values. For example, look-ahead buffer 720 may have information of the locations of zero entries in a kernel. Thus, control signals may be generated for neural engine 314 to skip an operation for MAD for a particular location in the kernel. Thus, instead of sequentially stepping through each kernel location of the kernel to perform an operation with the kernel coefficient associated with the kernel location, operations associated with the zero entries can be skipped.

FIG. 7B is a block diagram of kernel extract circuit 432a of neural engines 314, according to some embodiments. Kernel extract circuit 432a receives NE kernel data 526 from kernel access circuit 524 and extracts uncompressed kernel coefficients 422 without using block sparse masks. In some embodiments, kernel extract circuit 432a can assemble uncompressed kernel coefficients 422 using LUTs 502 and index data 510 as described above with reference to FIG. 6B.

Kernel extract circuit 432a may include, among other components, kernel decompressor 710, palettized look-up table storage LUTA through LUTN, reconstruction circuits 712A through 712N, kernel look-ahead buffer 720, MAD parameter buffer 721, and post-processor parameter buffer 722. In some embodiments, palettized look-up table storage LUTA through LUTN can store compressed kernel data obtained following a palettization process. In some embodiments, a palettization process refers to a process for compressing original kernel data to occupy smaller storage area. Kernel extract circuit 432a may include fewer or additional components than the components illustrated in FIG. 7B. Components of FIG. 7B perform the same or similar functions as the corresponding components as described above for FIG. 7A. Operations can be performed without using block sparse masks.

In some embodiments, neural engines 314 can implement a selection signal so that either kernel extract circuit 432 shown in FIG. 7A or kernel extract circuit 432a shown in FIG. 7B can be selected to perform the functions to generate uncompressed kernel coefficients 422. In some embodiments, when kernel coefficients 514 have high sparsity with many zero coefficients (e.g., a first sparsity value) in comparison with a predetermined threshold of the number of zeros, kernel extract circuit 432 shown in FIG. 7A with block spare masks can be selected (e.g., when the first sparsity value is greater than the predetermined threshold number of zeros). In some embodiments, when kernel coefficients 514 have low sparsity with few zero coefficients (e.g., second sparsity value) in comparison with the predetermined threshold of the number of zeros, kernel extract circuit 432a shown in FIG. 7B without a block spare mask can be used (e.g., when the second sparsity value is less than the predetermined threshold number of zeros).

### Example Processes of Neural Engine Architecture

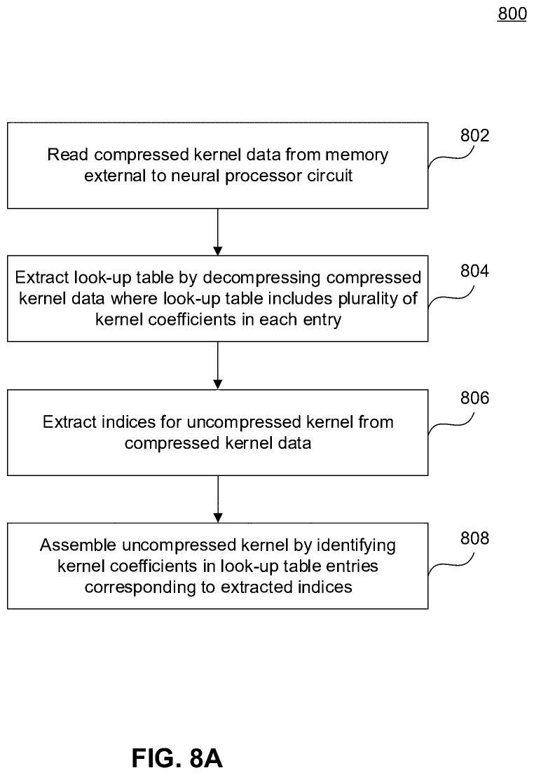

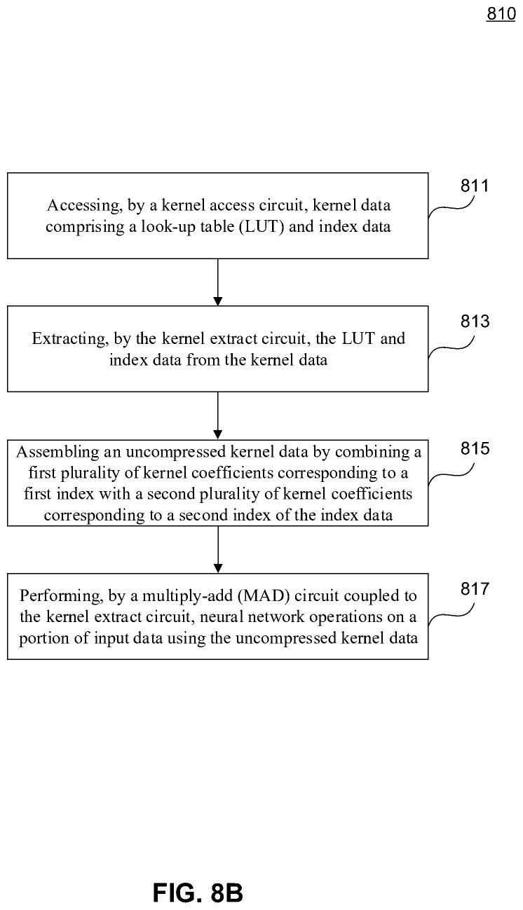

FIG. 8A is a flow chart illustrating a process 800 of decompressing compressed kernel data, according to some embodiments. For illustrative purposes, the operations illustrated in process 800 will be described with reference to kernel DMA 324 and kernel extract circuit 432 as shown in FIGS. 5A, 6A, and 7A. Other representations of systems for performing operations of process 800 are possible. Also, additional operations may be performed between various operations of process 800 and may be omitted merely for clarity and ease of description. The additional operations can be provided before, during, and/or after process 800. Moreover, not all operations may be needed to perform the disclosure provided herein. Additionally, some of the operations may be performed simultaneously or in a different order than shown in FIG. 8A. In some embodiments, one or more other operations may be performed in addition to or in place of the presently-described operations.

At operation 802, kernel DMA 324 receives compressed kernel data from system memory 230 that is external to neural processor circuit 218. Kernel DMA 324 sends compressed kernel data to neural engines 314.

At operation 804, from the compressed kernel data, kernel extract circuit 432 of neural engines 314 extracts one or more LUTs. In each LUT, each of its entries include kernel coefficients. These kernel coefficients are used for filling blocks of uncompressed kernel coefficients at locations where an associated block sparse mask indicates presence of at least one non-zero kernel value.

At operation 806, kernel extract circuit 432 extracts indices for the kernel from compressed kernel data. The indices may be included in the compressed kernel data as a series of numbers that indicate entries of the LUTs. The indices may be included in the compressed kernel data as index data.

At operation 808, kernel extract circuit 432 assembles the kernel by identifying the kernel coefficients in LUTs and filling corresponding locations of the kernel with the indices. In locations where the block sparse mask indicates zero kernel values, kernel extract circuit 432 fills them with zero values.

The process illustrated with FIG. 8A is merely illustrative, and various modifications may be made. For example, instead of performing extracting 804 of LUTs and extracting 806 of indices in series, both operations may be performed at least partly in parallel.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

FIG. 8B is a flow chart illustrating a process 810 of decompressing compressed kernel data, according to some embodiments. For illustrative purposes, the operations illustrated in process 810 will be described with reference to kernel access circuit 524 and kernel extract circuit 432 or 432a as shown in FIGS. 5B, 6B, and 7B. Other representations of systems for performing operations of process 810 are possible. Also, additional operations may be performed between various operations of process 810 and may be omitted merely for clarity and ease of description. The additional operations can be provided before, during, and/or after process 810. Moreover, not all operations may be needed to perform the disclosure provided herein. Additionally, some of the operations may be performed simultaneously or in a different order than shown in FIG. 8B. In some embodiments, one or more other operations may be performed in addition to or in place of the presently-described operations.

At operation 811, process 810 can include accessing, by kernel access circuit 524, kernel data 501 including LUT 502 and index data 510. In some embodiments, LUT 502 can have entries, where a first entry of the entries is identified by a first index and includes first kernel coefficients and a second entry of the entries is identified by a second index and includes second kernel coefficients. For example, entry 605 is identified by index 2 and includes kernel coefficients 0, C1, C2, and C3. Similarly, entry 607 is identified by index 3 and includes kernel coefficients D0, 0, 0, 0. In addition, index data 510 can include indices including the first index and the second index. For example, index data 510 can include indices 2, 3, 3, 0, and more.

At operation 813, process 810 can include extracting, by kernel extract circuit 432, LUT 502 and index data 510 from kernel data 501.

At operation 815, process 810 can include assembling, by kernel extract circuit 432, uncompressed kernel data 422 by combining the first kernel coefficients with the second kernel coefficients. For example, uncompressed kernel data 422 can include kernel coefficients 0, C1, C2, and C3 stored in entry 605 identified by index 2, and combined with D0, 0, 0, 0 stored in entry 607 identified by index 3, based on index data 510 including 2, 3, 3, 0.

At operation 817, process 810 can include performing, by a multiply-add (MAD) circuit coupled to the kernel extract circuit, neural network operations on a portion of input data using the uncompressed kernel data.

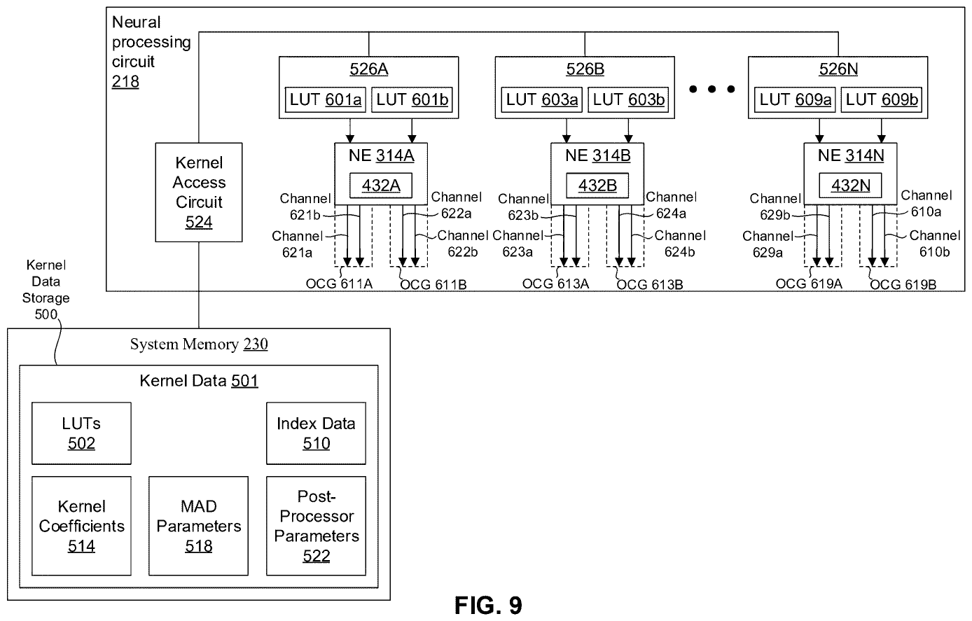

FIG. 9 is a block diagram illustrating multiple LUTs being assigned to output channels of multiple output channel groups (OCGs) of neural engine circuits of neural processor circuit 218, according to some embodiments. In some embodiments, neural processor circuit 218 shown herein can be an example of neural processor circuit 218 shown in FIG. 5B.

In some embodiments, kernel access circuit 524 can be configured to access kernel data 501. System memory 230 includes kernel data storage 500 that stores kernel data 501 associated with performing neural operations on neural engines 314. Kernel data 501 in kernel data storage 500 may be generated during a compilation process and may include data for multiple levels of ANN or multiple ANNs. Accordingly, kernel data 501 can include information for assembling kernels, such as LUTs 502, index data 510, kernel coefficients 514, MAD parameters 518, and post-processor parameters 522, as described in detail with reference to FIGS. 5A-5B and 6A-6B.

In some embodiments, neural processor circuit 218 can include kernel access circuit 524 and one or more neural engine circuits 314A, 314B, . . . , 314N. In some embodiments, each of neural engines may perform similar or the same functions as described below.

In some embodiments, for neural engine 314A, kernel access circuit 524 can access NE kernel data 526A and transmit NE kernel data 526A to neural engine 314A. Neural engine 314A can receive NE kernel data 526A that can include a first LUT 601a having first entries, a second LUT 601b having second entries, and index data 510 including indices. In some embodiments, there can be one or more other LUTs, e.g., LUT 601c. In some embodiments, LUT 601a can be different from LUT 601b. In some embodiments, an entry of LUT 601a can be identified by a first index of the indices of index data 510 and can include first kernel coefficients. In some embodiments, an entry of LUT 601b can be identified by a second index of the indices of index data 510 and can include second kernel coefficients. In some embodiments, an entry of LUT 601a or LUT 601b can include kernel coefficients including a zero. In some embodiments, kernel data 501 including LUT 601a, LUT 601b, and LUT 601c can be stored in system memory 230 shared by neural engine 314A and other neural engine circuits including neural engine 314B, . . . , neural engine 314N. In some embodiments, system memory 230 can be referred to by a system storage device as well. In some embodiments, LUT 601a, LUT 601b, and LUT 601c can be generated during a compilation process prior to kernel data 501 being accessed by kernel access circuit 524.

In some embodiments, neural engine 314A can include output channels, e.g., output channel 621a, output channel 621b, output channel 622a, and output channel 622b. In some embodiments, output channel 621a and output channel 621b can form a first output channel group (OCG) 611A, while output channel 622a and output channel 622b can form a second OCG 611B. In some embodiments, OCG 611A and OCG 611B can have non-overlapping output channels. Channels of neural engine 314A are divided into multiple OCGs for the purpose to assign different LUTs to different OCGs. In some embodiments, multiple LUTs can be assigned to a single OCG.

In some embodiments, neural engine 314A can include kernel extract circuit 432A configured to extract LUT 601a, LUT 601b, LUT 601c, and index data 510 from kernel data 501. In addition, kernel extract circuit 432A can assign LUT 601a and index data 510 for computing outputs of output channel 621a and output channel 621b of OCG 611A. Kernel extract circuit 432A can also assign LUT 601b and index data 510 for computing outputs of output channel 622a and output channel 622b of OCG 611B. In some embodiments, neural engine 314A can include an internal storage device configured to store the extracted LUT 601a and LUT 601b.

In some embodiments, kernel access circuit 524 can access kernel data 501 including one or more additional LUTs (e.g., LUT 601c) having entries, while kernel extract circuit 432A can extract LUT 601c from kernel data 501 and assign LUT 601c for computing outputs for output channels of OCG 611A. Accordingly, there can be multiple LUTs assigned for computing outputs for output channels of OCG 611A.

In some embodiments, neural engine 314A can include MAD circuit 534A coupled to kernel extract circuit 432A and configured to perform neural network operations on input data based on LUT 601a for computing the outputs for output channel 621a and output channel 621b of OCG 611A at a first time instance. Similarly, MAD circuit 534A can be configured to perform neural network operations on input data based on LUT 601b for computing the outputs for output channel 622a and output channel 622b of OCG 611B at a second time instance. In some embodiments, kernel data 501 can include MAD parameter 518 for configuring operations of MAD circuit 534A and post-processor parameter 522 for configuring a post-processor circuit in neural engine 314A. Kernel extract circuit 432A can extract MAD parameter 518 and post-processor parameter 522 from kernel data 501, send MAD parameter 518 to MAD circuit 534A, and send post-processor parameter 522 to the post-processor circuit.

In some embodiments, neural engine 314B can include kernel extract circuit 432B for performing functions similar to kernel extract circuit 432A of neural engine 314A, a MAD circuit, a post-processor circuit, as shown in FIG. 5B. In some embodiments, neural engine 314B can include output channels (e.g., output channel 623a, channel 623b, channel 624a, and channel 624b). In some embodiments, channel 623a and channel 623b can form a first output channel group (OCG) 613A, while channel 624a and channel 624b can form a second OCG 613B. In some embodiments, OCG 613A and OCG 613B can have non-overlapping output channels. Channels of neural engine 314B are divided into multiple OCGs for the purpose to assign different LUTs to different OCGs. In some embodiments, there can be multiple LUTs assigned to a single OCG. In some embodiments, OCG 613A of neural engine circuit 314B has a same number of output channels as OCG 611A of neural engine circuit 314A, and OCG 613B of neural engine circuit 314B has a same number of output channels as OCG 611B of neural engine circuit 314A.

In some embodiments, for neural engine 314B, kernel access circuit 524 can access NE kernel data 526B and transmit NE kernel data 526B to neural engine 314B. Neural engine 314B can receive NE kernel data 526B that can include a first LUT 603a having first entries, a second LUT 603b having second entries, and index data 510 including indices. In some embodiments, LUT 603a can be the same as LUT 601a provided to neural engine 314A, and LUT 603b can be the same as LUT 601b provided to neural engine 314A. In some embodiments, LUT 601a can be different from LUT 603a, and LUT 601b can be different from LUT 603b.

In some embodiments, neural engine 314B can include kernel extract circuit 432B configured to extract LUT 603a, LUT 603b, and index data 510 from kernel data 501. In addition, kernel extract circuit 432B can assign LUT 603a and index data 510 for computing outputs of output channel 623a and output channel 623b of OCG 613A. Kernel extract circuit 432B can also assign LUT 603b and index data 510 for computing outputs of output channel 624a and output channel 624b of OCG 613B.

In some embodiments, neural processor circuit 218 can include one or more neural engine circuits being provided by multiple LUTs. First LUTs, including LUT 601a and LUT 601b, can be assigned for computing outputs of output channels (e.g., output channel 621a, output channel 621b, output channel 622a, output channel 622b) of neural engine circuit 314A. Second LUTs, including LUT 603a and LUT 603b, are assigned for computing outputs of output channels (e.g., output channel 623a, output channel 623b, output channel 624a, output channel 624b) of neural engine circuit 314B. In some embodiments, LUT 601a and LUT 601b are different and do not have a common LUT with LUT 603a and LUT 603b.

In some embodiments, neural engine 314N can include kernel extract circuit 432N for performing functions similar to kernel extract circuit 432A of neural engine 314A, a MAD circuit, a post-processor circuit, as shown in FIG. 5B. In some embodiments, neural engine 314N can include output channels (e.g., output channel 629a, channel 629b, channel 630a, and channel 630b). In some embodiments, channel 629a and channel 629b can form a first OCG 619A, while channel 630a and channel 630b can form a second OCG 619B. In some embodiments, OCG 619A and OCG 619B can have non-overlapping output channels. Channels of neural engine 314N are divided into multiple OCGs for the purpose to assign different LUTs to different OCGs. In some embodiments, there can be multiple LUTs assigned to a single OCG. In some embodiments, OCG 619A of neural engine circuit 314N has a same number of output channels as OCG 611A of neural engine circuit 314A, and OCG 619B of neural engine circuit 314N has a same number of output channels as OCG 611B of neural engine circuit 314A.

In some embodiments, for neural engine 314N, kernel access circuit 524 can access NE kernel data 526N and transmit NE kernel data 526N to neural engine 314N. Neural engine 314N can receive NE kernel data 526N that can include a first LUT 609a having first entries, a second LUT 609b having second entries, and index data 510 including indices. In some embodiments, LUT 609a can be the same as LUT 601a provided to neural engine 314A, and LUT 609b can be the same as LUT 601b provided to neural engine 314A. In some embodiments, LUT 601a can be different from LUT 609a, and LUT 601b can be different from LUT 609b.

In some embodiments, neural engine 314N can include kernel extract circuit 432N configured to extract LUT 609a, LUT 609b, and index data 510 from kernel data 501. In addition, kernel extract circuit 432N can assign LUT 609a and index data 510 for computing outputs of output channel 629a and output channel 629b of OCG 619A. Kernel extract circuit 432N can also assign LUT 609b and index data 510 for computing outputs of output channel 630a and output channel 630b of OCG 619B. In some embodiments, LUT 601a and LUT 601b are all different and do not have a common LUT with LUT 609a and LUT 609b.

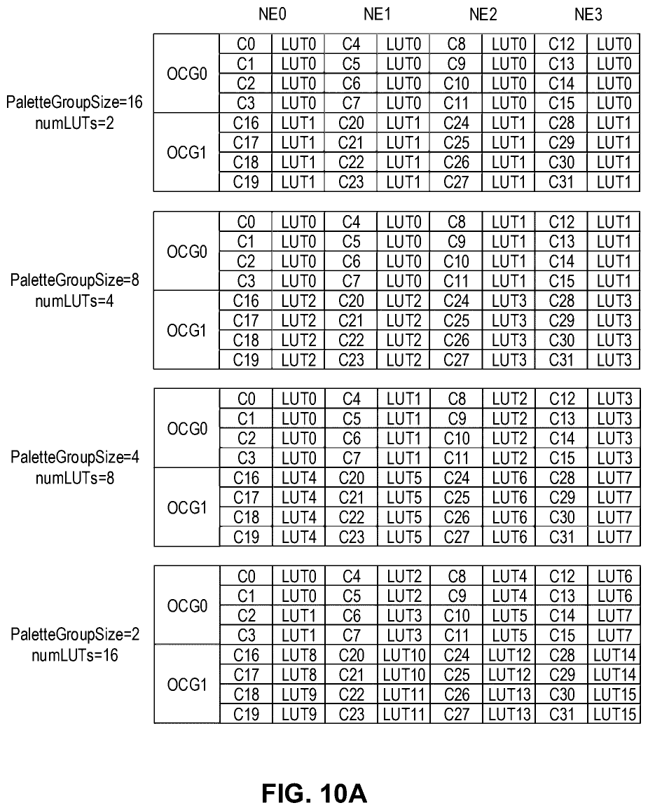

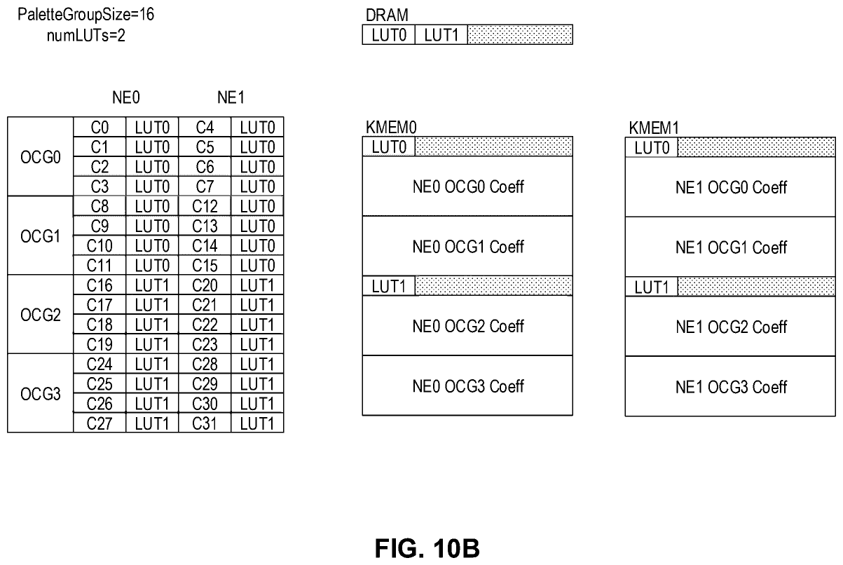

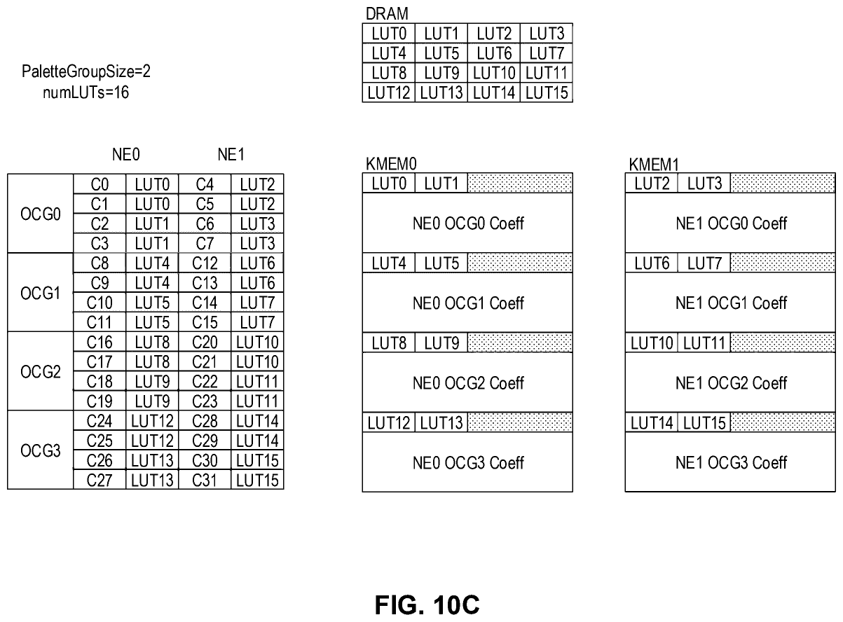

FIGS. 10A-10C are diagrams illustrating multiple LUTs assigned to output channels of multiple output channel groups (OCG) of neural engine circuits of neural processor circuit 218, according to some embodiments. In some embodiments, neural processor circuit 218 can have similar details as shown in FIGS. 5A, 5B, and 9

In some embodiments, as shown in FIG. 10A, neural processor circuit 218 can include multiple neural engine circuits, e.g., NE0, NE1, NE2, and NE3. Each neural engine circuit can have 8 output channels with a total of 32 channels for neural processor circuit 218. In some embodiments, NE0 can have output channels C0, C1, C2, and C3 classified as OCG0 for NE0, and output channels C16, C17, C18, and C19 classified as OCG1 for NE0. Similarly, NE1 can have output channels C4, C5, C6, and C7 classified as OCG0 for NE1, and output channels C20, C21, C22, and C23 classified as OCG1 for NE1. NE2 can have output channels C8, C9, C10, and C11 classified as OCG0 for NE2, and output channels C24, C25, C26, and C27 classified as OCG1 for NE2. NE3 can have output channels C12, C13, C14, and C15 classified as OCG0 for NE3, and output channels C28, C29, C30, and C31 classified as OCG1 for NE3.

In some embodiments, there can be various ways to assign multiple LUTs to output channels of multiple OCG of neural engine circuits of neural processor circuit 218.

In some embodiments, as shown in 1001, there can be 2 LUTs, LUT0 and LUT1, assigned to the total 32 output channels of OCG 0 and OCG 1 of neural engine circuits, e.g., NE0, NE1, NE2, and NE3, of neural processor circuit 218. For example, LUT0 is assigned to OCG0 of NE0, NE1, NE2, and NE3, while LUT1 is assigned to OCG1 of NE 0, NE 1, NE 2, and NE 3. Accordingly, a palette group size is 16 since 16 output channels share a same LUT, where the palette group size is the number of output channels sharing a same LUT.

In some embodiments, as shown in 1003, there can be 4 LUTs, LUT0, LUT1, LUT2, and LUT3, assigned to the total 32 output channels of OCG 0 and OCG 1 of neural engine circuits, e.g., NE0, NE1, NE2, and NE3, of neural processor circuit 218. Hence, the palette group size is 8. In detail, LUT0 is assigned to OCG 0 of NE 0, NE 1, LUT1 is assigned to OCG0 of NE2, NE3, LUT2 is assigned to OCG1 of NE0, NE1, and LUT3 is assigned to OCG1 of NE2, NE3.

In some embodiments, as shown in 1005, there can be 8 LUTs, LUT0, LUT1, LUT2, LUT3, LUT4, LUT5, LUT6, and LUT7, assigned to the total 32 output channels of OCG0 and OCG1 of neural engine circuits, e.g., NE0, NE1, NE2, and NE3, of neural processor circuit 218. Hence, the palette group size is 4. In detail, LUT0 is assigned to OCG0 of NE0, LUT1 is assigned to OCG0 of NE1, LUT2 is assigned to OCG0 of NE2, and LUT3 is assigned to OCG0 of NE3. Similarly, LUT4 is assigned to OCG1 of NE0, LUT5 is assigned to OCG1 of NE1, LUT6 is assigned to OCG1 of NE2, and LUT7 is assigned to OCG1 of NE3.

In some embodiments, as shown in 1007, there can be 16 LUTs, LUT0, LUT1, LUT2, LUT3, LUT4, LUT5, LUT6, LUT7, LUT8, LUT9, LUT10, LUT11, LUT12, LUT13, LUT14, and LUT15, assigned to the total 32 output channels of OCG0 and OCG1 of neural engine circuits, e.g., NE0, NE1, NE2, and NE3, of neural processor circuit 218. Hence, the palette group size is 2. Accordingly, each OCG can have two different LUTs assigned. In detail, LUT0 and LUT1 are assigned to OCG0 of NE0, LUT2 and LUT3 are assigned to OCG0 of NE1, LUT4 and LUT5 are assigned to OCG0 of NE2, LUT6 and LUT7 are assigned to OCG0 of NE3, LUT8 and LUT9 are assigned to OCG1 of NE0, LUT10 and LUT11 are assigned to OCG1 of NE1, LUT12 and LUT13 are assigned to OCG1 of NE2, and LUT14 and LUT15 are assigned to OCG1 of NE3.

In some embodiments, as shown in FIG. 10B, neural processor circuit 218 can include multiple neural engine circuits, e.g., NE0 and NE1. Each neural engine circuit can have 16 output channels with a total of 32 channels for neural processor circuit 218. Hence, the palette group size is 16.

In some embodiments, NE0 can have output channels classified into OCG0, OCG1, OCG2, and OCG3, where LUT0 is assigned to OCG0 and OCG1 of NE0, and LUT1 is assigned to OCG2 and OCG3 of NE0. Similarly, NE1 can have output channels classified into OCG0, OCG1, OCG2, and OCG3, where LUT0 is assigned to OCG0 and OCG1 of NE1, and LUT1 is assigned to OCG2 and OCG3 of NE1.

In some embodiments, LUT0 can have the kernel coefficients of OCG0 and OCG1 of NE0 stored in a first storage area 1011, and OCG0 and OCG1 of NE1 stored in a second storage area 1013. Similarly, LUT1 can store the kernel coefficients of OCG2 and OCG3 of NE0 stored in a first storage area 1015, and OCG2 and OCG3 of NE1 stored in a second storage area 1017.

In some embodiments, as shown in FIG. 10C, neural processor circuit 218 can include multiple neural engine circuits, e.g., NE0 and NE1. Each neural engine circuit can have 16 output channels with a total of 32 channels for neural processor circuit 218. Total 16 LUTs, LUT0, LUT1, LUT2, LUT3, LUT4, LUT5, LUT6, LUT7, LUT8, LUT9, LUT10, LUT11, LUT12, LUT13, LUT14, and LUT15, are assigned to output channels of NE0 and NE1. Hence, the palette group size is 2. Accordingly, each OCG can have two different LUTs assigned. In detail, LUT0 and LUT1 are assigned to OCG0 of NE0, which can be stored in storage area 1021; LUT2 and LUT3 are assigned to OCG0 of NE1, which can be stored in storage area 1023; LUT4 and LUT5 are assigned to OCG1 of NE0, which can be stored in storage area 1025; LUT6 and LUT7 are assigned to OCG1 of NE1, which can be stored in storage area 1027; LUT8 and LUT9 are assigned to OCG2 of NE0, which can be stored in storage area 1031; LUT10 and LUT11 are assigned to OCG2 of NE1, which can be stored in storage area 1033; LUT12 and LUT13 are assigned to OCG3 of NE0, which can be stored in storage area 1035; and LUT14 and LUT15 are assigned to OCG3 of NE1 which can be stored in storage area 1037.

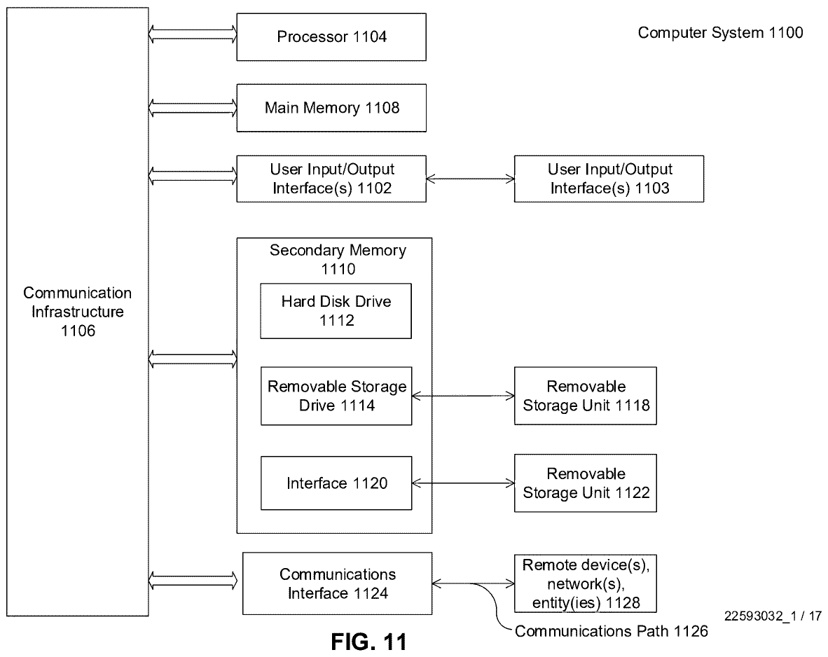

Various embodiments can be implemented, for example, using one or more computer systems, such as computer system 1100 shown in FIG. 11. Computer system 1100 can be any computer capable of performing the functions described herein for kernel access circuit 524, neural engine circuit 314, kernel DMA 324, kernel extract circuit 432, kernel extract circuit 432a, as shown in FIGS. 5A-5B, 6A-6B, 7A-7B, 8A-8B, 9, and 10A-10C. Computer system 1100 includes one or more processors (also called central processing units, or CPUs), such as a processor 1104. Processor 1104 is connected to a communication infrastructure 1106 (e.g., a bus). Computer system 1100 also includes user input/output device(s) 1103, such as monitors, keyboards, and pointing devices, that communicate with communication infrastructure 1106 through user input/output interface(s) 1102. Computer system 1100 also includes a main or primary memory 1108, such as random access memory (RAM). Main memory 1108 may include one or more levels of cache. Main memory 1108 has stored therein control logic (e.g., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 includes a computer usable or readable storage device having stored thereon computer software (e.g., control logic) and/or data. Removable storage unit 1118 may be a floppy disk, magnetic tape, compact disk, DVD, optical storage disk, /d/ any other computer data storage device. Removable storage drive 1114 reads from and/or writes to removable storage unit 1118 in a well-known manner.

According to some embodiments, secondary memory 1110 may include other means, instrumentalities or other approaches for allowing computer programs and/or other instructions and/or data to be accessed by computer system 1100. Such means, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (e.g., an EPROM or PROM) and associated socket, a memory stick and USB port, a memory card and associated memory card slot, and/or any other removable storage unit and associated interface.

In some examples, main memory 1108, the removable storage unit 1118, the removable storage unit 1122 can store instructions that, when executed by processor 1104, cause processor 1104 to perform operations for kernel access circuit 524, neural engine circuit 314, kernel DMA 324, kernel extract circuit 432, kernel extract circuit 432a, as shown in FIGS. 5A-5B, 6A-6B, 7A-7B, 8A-8B, 9, and 10A-10C.

Computer system 1100 may further include a communication or network interface 1124. Communication interface 1124 enables computer system 1100 to communicate and interact with any combination of remote devices, remote networks, remote entities, and other suitable devices (individually and collectively referenced by reference number 1128). For example, communication interface 1124 may allow computer system 1100 to communicate with remote devices 1128 over communications path 1126, which may be wired and/or wireless, and which may include any combination of LANs, WANs, the Internet, and any other suitable networks. Control logic and/or data may be transmitted to and from computer system 1100 via communication path 1126.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (e, g., software) stored thereon is also referred to herein as a “computer program product” or “program storage device.” This includes, but is not limited to, computer system 1100, main memory 1108, secondary memory 1110 and removable storage units 1118 and 1122, as well as tangible articles of manufacture embodying any combination of the foregoing. Such control logic, when executed by one or more data processing devices (e.g., computer system 1100), causes such data processing devices to operate as described herein.

Based on the teachings in this disclosure, it will be apparent to persons skilled in the relevant art(s) how to make and use embodiments of the disclosure using data processing devices, computer systems and/or computer architectures other than that shown in FIG. 11. In particular, embodiments may operate with software, hardware, and/or operating system implementations other than those described herein.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages can depend on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (e.g., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (e.g., having the potential to, being able to) and not in a mandatory sense (e.g., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” and “given circuit”) refer to different instances of the feature. Additionally, the labels “first,” “second,” and “third” when applied to a feature do not imply any type of ordering (e.g., spatial, temporal, and logical), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

In this disclosure, different entities (which may variously be referred to as “units,” “circuits,” and “other components”) may be described or claimed as “configured” to perform one or more tasks or operations. This formulation—[entity] configured to [perform one or more tasks]—is used herein to refer to structure (e.g., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, and latches), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be referred to as “units” (e.g., a decode unit, an arithmetic logic unit (ALU), functional unit, and memory management unit (MMU)). Such units also refer to circuits or circuitry.

The disclosed circuits/units/components and other elements illustrated in the drawings and described herein thus include hardware elements such as those described in the preceding paragraph. In many instances, the internal arrangement of hardware elements in a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description can be expressed in a fashion that may appear to be functional. But to those of skill in the art in this field, this HDL description is the manner that is used to transform the structure of a circuit, unit, or component to the next level of implementational detail. Such an HDL description may take the form of behavioral code (which may not be synthesizable), register transfer language (RTL) code (which, in contrast to behavioral code, may be synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, and inductors) and interconnect between the transistors and circuit elements. Some embodiments may implement multiple integrated circuits coupled to one another to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits may result in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

What is claimed is:

1. A neural processor circuit, comprising:
a kernel access circuit configured to access kernel data comprising:
a first look-up table (LUT) having a first plurality of entries;
a second LUT having a second plurality of entries; and
index data comprising a plurality of indices; and
a neural engine circuit comprising a plurality of output channels and configured to receive the kernel data from the kernel access circuit, wherein the neural engine circuit comprises a kernel extract circuit configured to:
extract the first LUT and the index data from the kernel data and assign the first LUT and the index data for computing outputs of output channels of a first output channel group (OCG) of the plurality of output channels; and
extract the second LUT from the kernel data and assign the second LUT and the index data for computing outputs of output channels of a second OCG of the plurality of output channels.

2. The neural processor circuit of claim 1, wherein the first LUT is different from the second LUT.

3. The neural processor circuit of claim 1, wherein an entry of the first LUT is identified by a first index of the plurality of indices and comprises a first plurality of kernel coefficients, and wherein an entry of the second LUT is identified by a second index of the plurality of indices and comprises a second plurality of kernel coefficients.

4. The neural processor circuit of claim 1, wherein the first OCG and the second OCG have non-overlapping output channels.

5. The neural processor circuit of claim 1, wherein the kernel data comprising the first LUT and the second LUT are stored in a system storage device shared by the neural engine circuit and a plurality of other neural engine circuits of the neural processor circuit and provided to the kernel access circuit from the system storage device.

6. The neural processor circuit of claim 1, wherein the neural engine circuit further comprises an internal storage device configured to store the extracted first LUT and the extracted second LUT.

7. The neural processor circuit of claim 1, wherein the neural engine circuit further comprises a multiply-add (MAD) circuit coupled to the kernel extract circuit and configured to perform neural network operations on input data based on the first LUT for computing the outputs for output channels of the first OCG at a first time instance and for computing the outputs for output channels of the second OCG at a second time instance.

8. The neural processor circuit of claim 1, wherein the neural engine circuit is a first neural engine circuit, the kernel extract circuit is a first kernel extract circuit, and the neural processor circuit further comprises a second neural engine circuit that comprises a second kernel extract circuit configured to:
extract the first LUT and the index data from the kernel data and assign the first LUT for computing outputs for output channels of a first OCG of the second neural engine circuit; and
extract the second LUT from the kernel data and assign the second LUT for computing outputs for output channels of a second OCG of the second neural engine circuit.

9. The neural processor circuit of claim 8, wherein the first OCG of the second neural engine circuit has a same number of output channels as the first OCG of the first neural engine circuit, and wherein the second OCG of the second neural engine circuit has a same number of output channels as the second OCG of the second neural engine circuit.

10. The neural processor circuit of claim 8, wherein the kernel access circuit is further configured to access kernel data comprising a third LUT having a third plurality of entries and a fourth LUT having a fourth plurality of entries, and wherein the neural processor circuit further comprises a third neural engine circuit comprising a third kernel extract circuit configured to:
extract the third LUT and the index data from the kernel data and assign the third LUT for computing outputs for output channels of a first OCG of the third neural engine circuit; and
extract the fourth LUT from the kernel data and assign the fourth LUT for computing outputs for output channels of a second OCG of the third neural engine circuit.

11. The neural processor circuit of claim 1, wherein the neural engine circuit is a first neural engine circuit and the neural processor circuit further comprises a second neural engine circuit, wherein a first plurality of LUTs including the first LUT and the second LUT are assigned for computing outputs of output channels of the first neural engine circuit, and a second plurality of LUTs are assigned for computing outputs of output channels of the second neural engine circuit, and wherein the first plurality of LUTs and the second plurality of LUTs do not have a common LUT.

12. The neural processor circuit of claim 1, wherein the kernel access circuit is further configured to access kernel data comprising a third LUT having a third plurality of entries, and wherein the kernel extract circuit is further configured to:
extract the third LUT from the kernel data and assign the third LUT for computing outputs for output channels of the first OCG of the neural engine circuit.

13. The neural processor circuit of claim 1, wherein an entry of the first LUT comprises a first plurality of kernel coefficients comprising a zero.

14. A method of operating a neural processor circuit, comprising:
accessing, by a kernel access circuit, kernel data comprising:
a first look-up table (LUT) having a first plurality of entries;
a second LUT having a second plurality of entries; and
index data comprising a plurality of indices;
extracting, by a kernel extract circuit of a neural engine circuit, the first LUT, the second LUT, and the index data from the kernel data;
assigning the first LUT and the index data for computing outputs of output channels of a first output channel group (OCG) of a plurality of output channels of the neural engine circuit;
assigning the second LUT and the index data for computing outputs of output channels of a second OCG of the plurality of output channels; and
performing, by a multiply-add (MAD) circuit coupled to the kernel extract circuit, neural network operations on input data based on the first LUT for computing the outputs for output channels of the first OCG at a first time instance and for computing the outputs for output channels of the second OCG at a second time instance.

15. The method of claim 14, wherein the first LUT is different from the second LUT, and wherein the first OCG and the second OCG have non-overlapping output channels.

16. The method of claim 14, wherein the first LUT and the second LUT are generated during a compilation process prior to the kernel data being accessed by the kernel access circuit.

17. The method of claim 14, further comprising:
accessing, by the kernel access circuit, kernel data comprising a third LUT having a third plurality of entries;
extracting the third LUT from the kernel data; and
assigning the third LUT for computing outputs for output channels of the first OCG of the neural engine circuit.

18. An electronic device, comprising:
a system memory storing input data; and
a kernel access circuit configured to access kernel data comprising:
a first look-up table (LUT) having a first plurality of entries;
a second LUT having a second plurality of entries; and
index data comprising a plurality of indices; and
a neural engine circuit comprising a plurality of output channels and configured to receive the kernel data from the kernel access circuit, wherein the neural engine circuit comprises:
a kernel extract circuit configured to:
extract the first LUT and the index data from the kernel data and assign the first LUT and the index data for computing outputs of output channels of a first output channel group (OCG) of the plurality of output channels; and
extract the second LUT from the kernel data and assign the second LUT and the index data for computing outputs of output channels of a second OCG of the plurality of output channels; and
a multiply-add (MAD) circuit coupled to the kernel extract circuit and configured to perform neural network operations on the input data stored in the system memory based on the first LUT for computing the outputs for output channels of the first OCG at a first time instance and for computing the outputs for output channels of the second OCG at a second time instance.

19. The electronic device of claim 18, wherein the kernel data comprises:
a MAD parameter for configuring operations of the MAD circuit; and
a post-processor parameter for configuring a post-processor circuit in the neural engine circuit.

20. The electronic device of claim 19, wherein the kernel extract circuit is further configured to:
extract the MAD parameter and the post-processor parameter from the kernel data;
send the MAD parameter to the MAD circuit; and
send the post-processor parameter to the post-processor circuit.
